(19) United States
(12) Patent Application Publication
(10) Pub. No.: US 2020/0172835 A1
(43) Pub. Date: Jun. 4, 2020

(54) DETERGENTS AND CLEANERS WITH IMPROVED CLEANING POWER THROUGH THE USE OF CARBOHYDRATES

(71) Applicant: Henkel AG & Co. KGaA, Duesseldorf (DE)

(72) Inventors: Sascha SCHAEFER, Mettmann (DE); Anna KLEMMER, Duesseldorf (DE); Michael STROTZ, Koeln (DE)

(21) Appl. No.: 16/699,005

(22) Filed: Nov. 28, 2019

(30) Foreign Application Priority Data
Nov. 29, 2018 (DE) 10 2018 130 352.1

(51) Int. Cl. C11D 3/22; C11D 1/66; C11D 1/34; C11D 3/386; C11D 3/37

(52) U.S. Cl. CPC C11D 3/221; C11D 1/66; C11D 1/34; C11D 3/3773; C11D 3/38627; C11D 3/3765; C11D 3/38618

(57) ABSTRACT

A liquid aqueous composition comprises or consists of a) at least one specific carbohydrate or a derivative thereof and b) at least one surfactant. A detergent or cleaner may include the liquid aqueous composition. In addition, the use of the liquid, aqueous composition as a detergent or cleaner for an improved stain removal and the use of the specific carbohydrate or a derivative thereof as a stain remover is also disclosed.

### CROSS-REFERENCE TO RELATED APPLICATION

The present application claims priority to German Patent Application Serial No.: 10 2018 130 352.1 according to 35 U.S.C. § 119, which was filed on Nov. 29, 2018; which is incorporated herein by reference in its entirety and for all purposes.

### TECHNICAL FIELD

The present invention relates to a liquid, aqueous composition which comprises or consists of a) at least one specific carbohydrate or a derivative thereof and b) at least one surfactant. The invention further relates to a detergent or cleaner which comprises or consists of the liquid, aqueous composition. In addition, the use of the liquid, aqueous composition as a detergent or cleaner of the present invention for an improved stain removal and the use of the specific carbohydrate or a derivative thereof as a stain remover are claimed.

### BACKGROUND

There is a need for liquid detergents and cleaners that generally have an improved efficiency and cleaning power with regard to a wide range of soil particles and/or that specifically act against certain soil particles, particularly difficult soil particles such as blood, blueberry juice or drippings.

Consumers also want eco-friendly detergents and cleaners based on renewable raw materials that minimize dependency on fossil resources.

In general, the use of carbohydrates in detergents and cleaners is already known.

EP 0 814 088 B1, for example, describes the use of acylated carbohydrates having least one etherified carboxyalkyl group in detergents as a complexing agent with simultaneous bleach-activating action.

WO 2012 098522 A2 discloses a solid detergent composition comprising from approx. 0.1 to approx. 70 wt. % of at least one alkali metal silicate; from approx. 0.5 to approx. 10 wt. % of at least one saccharide or sugar alcohol and from approx. 10 to approx. 70 wt. % of water.

However, none of these documents discloses a liquid, aqueous detergent- and cleaner composition containing the specific carbohydrates suitable for this particular application. Moreover, they do not disclose that the compositions of the above-mentioned documents are suitable for the removal of difficult dirt particles, such as blood, blueberry juice or drippings.

### SUMMARY

Therefore, in a first aspect, a liquid, aqueous composition may comprise or consist of
a) at least one carbohydrate or a derivative thereof which has an acid value of <10 mg KOH/g and in which the basic carbohydrate structure has a molecular mass of 140 to 540 g/mol;
b) at least one surfactant;
c) optionally at least one complexing agent;
d) optionally at least one polymer;
e) optionally at least one enzyme; and
f) optionally at least one excipient.

In a second aspect, a detergent or cleaner, may comprise or consist of the liquid, aqueous composition according to aspect 1.

Furthermore, in a third aspect, the use of the liquid, aqueous composition as a detergent or cleaner for improved stain removal.

Finally, in a fourth aspect, at least one carbohydrate or a derivative thereof may be used as a stain remover, wherein the carbohydrate has an acid value of <10 mg KOH/g and wherein the basic carbohydrate structure has a molecular mass of 140 to 540 g/mol.

### DETAILED DESCRIPTION

Surprisingly, it was found that the problems mentioned can be solved by a liquid, aqueous composition which comprises a) at least one specific carbohydrate or a derivative thereof which has an acid value of <10 mg KOH/g and whose basic carbohydrate structure has a molecular mass of 140 to 540 g/mol and b) at least one surfactant.

“At least one,” as used herein, refers to 1 or more, for example, 2, 3, 4, 5, 6, 7, 8, 9 or more. In connection with the components of the compound described herein, this information does not refer to the absolute amount of molecules but to the type of the component. “At least one carbohydrate” therefore means, for example, that only one type of carbohydrate compound or several different types of carbohydrate compounds may be present, but it does not provide any information about the quantity of the individual compounds.

Unless otherwise indicated, all quantities indicated in connection with the compositions described herein refer to wt. % in each case based on the total weight of the liquid composition. Moreover, quantities that relate to at least one component always relate to the total quantity of this type of component contained in the liquid, aqueous composition unless explicitly indicated otherwise. That means that this type of quantity information, for example in the context of “at least one carbohydrate,” refers to the total quantity of carbohydrates contained in the liquid composition unless explicitly indicated otherwise.

Numbers without decimals stated herein refer to the full value with one decimal place. For example, “99%” stands for “99.0%.”

The terms “about” or “approximately” in the context of a numerical value refer to a variance of ±10% based on the given numerical value, preferably ±5%, and more preferably ±1%.

The term “substantially free of” means that in some embodiments, for example, phosphone-containing complexing agents may indeed be included in principle, but they are present in a quantity that does not support a function as a complexing agent. In the context, therefore, the property “substantially free of complexing agents based on a phosphonic acid or a suitable salt thereof” refers to a total weight of these complexing agents of less than 0.1 wt. %, preferably less than 0.001 wt. %, in particular free of this complexing agent, based on the total weight of the liquid, aqueous composition.

The terms “carbohydrate,” “saccharide,” “polyol” and/or “sugar” are used synonymously throughout this application. The term “carbohydrate” also includes all regioisomers and stereoisomers of a compound. Furthermore, both polyhydroxy aldehydes (aldoses) and polyhydroxy ketones (ketoses) may fall under the term “carbohydrate” as long as they have an acid value of <10 mg KOH/g and a molecular mass of 140 to 540 g/mol.

The term derivative, in the context of “at least one carbohydrate or derivative thereof,” refers to substituted and/or protected carbohydrates.

A hydrogen atom of the carbohydrate compound may be replaced by a substituent by substitution. Non-limiting substituents are, for example, hydroxy, alkoxy, amino, nitro, amido, fluoro, chloro, bromo, iodine, carbonyl, carboxyl, ester, ether, mercapto, sulfonyl, cyano, or linear or branched alkyl, alkenyl, alkynyl, cycloalkyl, aryl, alkyl cycloalkyl, alkyl cycloalkenyl, alkenyl cycloalkyl, alkenyl cycloalkenyl, alkylaryl, alkynyl cycloalkyl, alkynyl cycloalkenyl, alkynyl aryl, or alkenyl aryl groups having up to 15 C atoms, which may contain at least one heteroatom, such as N, O, S, Si or P.

The derivatives of carbohydrate compounds may further include suitable protective groups as substituents. Non-limiting protective groups are, for example, C₁-C₁₈ alkyl, phenyl, benzyl, acetyl, benzoyl, methane sulfonyl, tosyl, trimethylsilyl, triethylsilyl, tert. butyldimethylsilyl, triisopropylsilyl, tert. butyldiphenylsilyl, adamantyl or pivaloyl groups.

The term “molecular mass of the basic carbohydrate structure” is either, in the case of unsubstituted and unprotected carbohydrates, the molecular mass of the carbohydrate or, in the case of substituted and/or protected carbohydrates, the molecular mass of the corresponding unprotected and/or unsubstituted carbohydrate. In the case of a substituted and/or protected compound, the molecular mass is thus calculated starting from the educt without taking into account the substituents/protective groups. Thus, the molecular mass of 140 to 540 g/mol always refers to the unsubstituted or unprotected compound. This means that the molecular mass of the protective group(s) and/or the substituent(s) is not included in the molecular mass of 140 to 540 g/mol of the carbohydrate. The following examples illustrate this:

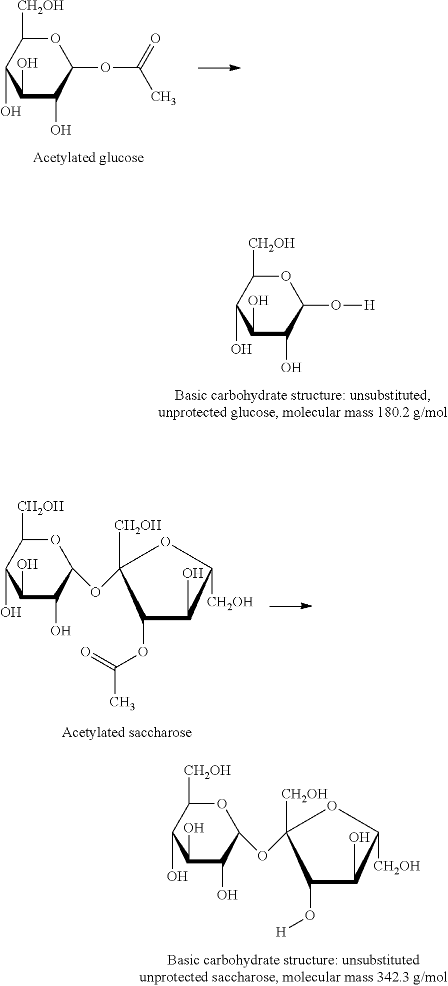

The acid value of the carbohydrates or derivatives thereof that are suitable refers to the mass of potassium hydroxide (KOH) in mg that is needed to neutralize the acidity of 1 g of the carbohydrate compound or a derivative thereof. According to EN ISO 660: 2009, which to the determination of the acid value of fatty acids and fats, the sample is dissolved in a suitable solvent (mixture) and the acids present are titrated with an ethanolic or methanolic KOH solution, in particular standard solutions of 0.1 mol/L and 0.5 mol/L. A sodium hydroxide (NaOH) solution can be used for titration as well. Phenolphthalein is used for the end point determination. Other suitable indicators are, for example, alkali blue or thymolphthalein.

These and other aspects, features and advantages will become apparent to a person skilled in the art from the following detailed description and claims. Any feature from one aspect of the invention can be used in any other aspect of the invention. Furthermore, it is clear that the examples contained herein are intended to describe and illustrate but not limit the invention, and in particular, the invention is not limited to these examples.

Carbohydrates which are are mono-, di- or trisaccharides or derivatives thereof but are not limited thereto. In an embodiment, the mono-, di- or trisaccharides or the derivatives thereof have an acid value of <10 mg KOH/g, and the basic carbohydrate structure has a molecular mass of 140 to 540 g/mol.

In an embodiment, the liquid, aqueous composition comprises at least one monosaccharide selected from the group consisting of allose, altrose, gulose, idose, talose, glucose, mannose, rhamnose, galactose, ribose, arabinose, lyxose, xylose or a derivative thereof. At least one monosaccharide is selected from the group consisting of glucose, mannose, galactose, xylose or a derivative thereof, such as from glucose, mannose, galactose or xylose.

Di- and trisaccharides are typically composed of glycosidically-linked monosaccharides. A carbon atom of a carbohydrate binds to a heteroatom, in particular O, of another carbohydrate.

In an embodiment, the liquid, aqueous composition comprises at least one disaccharide selected from the group consisting of maltose, lactose, cellobiose, gentiobiose, isomaltose, isomaltulose, lactulose, laminaribiose, maltulose, melibiose, neohesperidosis, neotrehalose, nigerose, rutinose, sambubiose, sophorose, trehalose, sucrose or a derivative thereof, such as selected from the group consisting of maltose, sucrose or a derivative thereof.

In an embodiment, the liquid, aqueous composition contains at least one trisaccharide selected from the group consisting of fucosidolactose, gentianose, isokestose, kestose, manninotriose, melezitose, neokestose, panose, umbelliferose, raffinose, maltotriose or a derivative thereof; such as selected from the group consisting of raffinose, maltotriose or a derivative thereof.

In an embodiment, the liquid, aqueous composition comprises at least one monosaccharide selected from the group consisting of allose, altrose, gulose, idose, talose, glucose, mannose, rhamnose, galactose, ribose, arabinose, lyxose, xylose or a derivative thereof, and/or a disaccharide selected from the group consisting of maltose, lactose, cellobiose, gentiobiose, isomaltose, isomaltulose, lactulose, laminaribiose, maltulose, melibiose, neohesperidose, neotrehalose, nigerose, rutinose, sambubiose, sophorose, trehalose, sucrose or a derivative thereof and/or a trisaccharide selected from the group consisting of fucosidolactose, gentianose, isokestose, kestose, manninotriose, melezitose, neokestose, panose, umbelliferose, raffinose, maltotriose or a derivative thereof; such as a monosaccharide selected from the group consisting of glucose, mannose, galactose, xylose or a derivative thereof, and/or a disaccharide selected from the group consisting of maltose, sucrose or a derivative thereof, and/or a trisaccharide selected from the group consisting of raffinose, maltotriose or a derivative thereof; i.e. a monosaccharide selected from the group consisting of glucose, mannose, galactose or xylose, and/or a disaccharide selected from the group consisting of maltose or sucrose, and/or a trisaccharide selected from the group consisting of raffinose or maltotriose.

In further embodiments, the liquid, aqueous composition contains a mixture of different carbohydrates or derivatives thereof, such as a mixture of mono- and/or di- and/or trisaccharides, and/or derivatives thereof.

A liquid aqueous composition may include at least one disaccharide selected from the group consisting of maltose, lactose, cellobiose, gentiobiose, isomaltose, isomaltulose, lactulose, laminaribiose, maltulose, melibiose, neohesperidosis, neotrehalose, nigerose, rutinose, sambubiose, sophorose, trehalose, sucrose or a derivative thereof, such as selected from the group consisting of maltose, sucrose or a derivative thereof.

In an embodiment, the liquid, aqueous composition contains at least one carbohydrate or derivative thereof having an acid value of <9.5 mg KOH/g, such as of <7.0 mg KOH/g, for example of <5 mg KOH/g, i.e. of <4 mg KOH/g, such as of <3 mg KOH/g, for example of <2 mg KOH/g, and i.e. of <1 mg KOH/g.

In an embodiment, the liquid, aqueous composition contains at least one carbohydrate or a derivative thereof, wherein the basic carbohydrate structure has a molecular mass of 140 to 535 g/mol, such as 145 to 530 g/mol, for example 150 to 520 g, i.e. from 160 to 510 g/mol, such as from 170 to 450 g/mol, for example from 175 to 400 g/mol, i.e. from 178 to 360 g/mol, such as from 250 to 360 g/mol, and from 300 to 360 g/mol.

In an embodiment, the liquid aqueous composition contains at least one carbohydrate or a derivative thereof in which the basic carbohydrate structure has a molecular mass of from 180 to 540 g/mol.

In various embodiments, any of the named upper limits of the molecular mass of the at least one carbohydrate or a derivative thereof may be combined with any of the named lower limits of the molecular mass.

In an embodiment, the liquid, aqueous composition contains at least one carbohydrate, wherein the basic carbohydrate structure has a molecular mass of <540 g/mol, such as <510 g/mol, for example <450 g/mol, i.e. <400 g/mol, such as <380 g/mol, i.e. <360 g/mol.

According to non-limiting embodiments, each of the acid values named may be combined with each of the molecular masses named to define the at least one carbohydrate or a derivative thereof.

In a further embodiment, the liquid, aqueous composition contains at least one carbohydrate or a derivative thereof which has an acid value of <10 mg KOH/g and in which the basic carbohydrate structure has a molecular mass of 140 to 540 g/mol in a quantity from 0.01 to 40 wt. %, such as from 0.1 to 30 wt. %, for example from 0.5 to 20 wt. %, based on the total weight of the liquid, aqueous composition.

In further liquid aqueous compositions, the at least one carbohydrate or a derivative thereof having an acid value of <10 mg KOH/g and wherein the basic carbohydrate structure has a molecular mass of 140 to 540 g/mol is contained in a quantity of 0.55 to 15 wt. %, such as from 0.6 to 10 wt. %, from 0.65 to 5 wt. %, based on the total weight of the liquid, aqueous composition.

In a further embodiment, the liquid, aqueous composition contains at least one mono-, di- or trisaccharide or a derivative thereof which has an acid value of <10 mg KOH/g and in which the basic carbohydrate structure has a molecular mass of 140 to 540 g/mol in a quantity from 0.01 to 40 wt. %, such as from 0.1 to 30 wt. %, for example from 0.5 to 20 wt. %, i.e. from 0.55 to 15 wt. %, such as from 0.6 to 10 wt. %, for example from 0.65 to 5 wt. %, based on the total weight of the liquid, aqueous composition.

In a further embodiment, the liquid, aqueous composition contains at least one disaccharide selected from the group consisting of maltose, lactose, cellobiose, gentiobiose, isomaltose, isomaltulose, lactulose, laminaribiose, maltulose, melibiose, neohesperidosis, neotrehalose, nigerose, rutinose, sambubiose, sophorose, trehalose, sucrose or a derivative thereof, such as from the group consisting of maltose, sucrose or a derivative thereof, for example from the group consisting of maltose or sucrose, which has an acid value of <10 mg KOH/g and wherein the basic carbohydrate structure has a molecular mass of 140 to 540 g/mol, such as <360 g/mol, and in a quantity from 0.01 to 40 wt. %, for example from 0.1 to 30 wt. %, i.e. from 0.5 to 20 wt. %, such as from 0.55 to 15 wt. %, such as from 0.6 to 10 wt. %, for example from 0.65 to 5 wt. %, based on the total weight of the liquid, aqueous composition.

The addition of carbohydrates, in particular of at least one carbohydrate or a derivative thereof, which has an acid value of <10 mg KOH/g and in which the basic carbohydrate structure has a molecular mass of 140 to 540 g/mol, to the compositions may contribute to the stabilization of enzymes, in particular of amylases, in the liquid, aqueous composition. Furthermore, the carbohydrates mentioned may act as complexing agents. This leads to a prolonged storage stability of the composition.

Furthermore, the liquid, aqueous composition contains at least one surfactant.

The compositions may contain as a surfactant component one or more nonionic, anionic, amphoteric or cationic surfactants or surfactant mixtures of one, several or all of these classes of surfactants.

In embodiments, the at least one surfactant is in a quantity from 0.01 to 45 wt. %, such as from 0.1 to 30 wt. %, for example from 0.5 to 15 wt. %, i.e. from 1 to 10 wt. %, based on the total weight of the liquid, aqueous composition.

In a further embodiment, the at least one surfactant comprises an anionic surfactant, such as a linear or branched, secondary alkyl sulfonate; and/or wherein the at least one surfactant is contained in an amount from 0.01 to 45 wt. %, such as from 0.1 to 30 wt. %, for example from 0.5 to 15 wt. %, i.e. from 1 to 10 wt. %, based on the total weight of the liquid, aqueous composition.

Anionic surfactants are useful for economic reasons and because of their performance spectrum. The surfactants of the individual groups may be used as individual substances. Mixtures of surfactants may include, in particular, those from anionic in combination with one or more nonionic surfactants or betaine surfactants, which are having to be equated in this context with the class of amphoteric surfactants. The joint additional use of nonionic surfactants and betaine surfactants in a mixture can also be advantageous for many applications.

Anionic surfactants, which can be used, may be aliphatic sulfates such as fatty alcohol sulfates, fatty alcohol ether sulfates, dialkyl ether sulfates, monoglyceride sulfates and also aliphatic and aromatic sulfonates such as alkane sulfonates, olefin sulfonates, ether sulfonates, n-alkyl ether sulfonates, ester sulfonates, lignin sulfonates and alkylbenzene sulfonates. Also usable are fatty acid cyanamides, sulfosuccinic acid esters, fatty acid isothionates, acylaminoalkanesulfonates (fatty acid taurides), fatty acid sarcosinates, ether carboxylic acids and alkyl (ether) phosphates.

The alkali salts and in particular the sodium salts of the sulfuric acid half-esters of C₁₂-C₁₈ fatty alcohols, for example from coconut fatty alcohol, tallow fatty alcohol, lauryl alcohol, myristyl alcohol, cetyl alcohol or stearyl alcohol, or of C₁₀-C₂₀ oxo alcohols and the half-esters of secondary alcohols (secondary alkyl sulfates) having these chain lengths are as alk(en)yl sulfates. Secondary alcohols are compounds whose OH group is linked to a carbon atom attached to two other carbon atoms. Analogously, secondary alkyl sulfates are compounds whose sulfate group is linked to a carbon atom attached to two other carbons. The hydrocarbon chain is linear or branched, having up to 20 carbon atoms. Alk(en)yl sulfates having the described chain length that include a synthetic straight-chain alkyl group prepared on a petrochemical basis and having a degradation behavior analogous to that of the adequate compounds based on fatty chemical raw materials are as well. From a washing perspective, C₁₂-C₁₆ alkyl sulfates, C₁₂-C₁₅ alkyl sulfates and C₁₄-C₁₅ alkyl sulfates may be used. Suitable secondary alkyl sulfates containing 2- and/or 3-alkyl sulfates and optionally higher homologs (4-, 5-, 6-alkyl sulfates, etc.) can be prepared, for example, according to U.S. Pat. No. 3,234,258 or 5,075,041 and are available as commercial products from the Shell Oil Company under the name DAN®, e.g. the products DAN® 214, a C₁₄-SAS with 99% 2- and 3-alkyl sulfate, DAN® 216, a C₁₆-SAS with 99% 2- and 3-alkyl sulfate, and DAN® 100, a SAS with 62% 2- and 3-alkyl sulfate, which are mentioned in the U.S. Pat. No. 5,529,724 and H 1,665.

The fatty alcohol ether sulfates may be used. Fatty alcohol ether sulfates are products of sulfating reactions on alkoxylated alcohols.

A person skilled in the art generally understands the term alkoxylated alcohols to refer to the reaction products of one or more alkylene oxides, such as of ethylene oxide, with alcohols, such as the longer-chain alcohols, for example the straight-chain or branched alcohols with chain lengths of C₇ to C₂₁ such as 2-methyl branched C₉- to C₁₁-fatty alcohols with an average of 3.5 EO or C₁₂- to C₁₈-fatty alcohols with 1 to 4 EO. In general, the result of n moles ethylene oxide and one mol alcohol is, depending on the reaction conditions, a complex mixture of addition products having varying degrees of ethoxylation. A further embodiment of the alkoxylation consists in the use of mixtures of the alkylene oxides, such as the mixture of ethylene oxide and propylene oxide. Low-ethoxylated fatty alcohols may also be used (0.5 to 4 moles of EO, such as 1 to 2 moles of EO).

The alkane sulfonates, in particular the secondary alkane sulfonates, may be obtainable from straight-chain paraffin hydrocarbons, in particular C₁₂₋₁₈-alkanes, for example by sulfochlorination or sulfoxidation and subsequent hydrolysis or neutralization. A secondary alkane sulfonate is the secondary Na—C₁₃₋₁₇ alkane sulfonate marketed as Hostapur® SAS 60 sold by Clariant.

Other surfactants of the sulfonate type to be taken into consideration are alkylbenzene sulfonates, olefin sulfonates, i.e. mixtures of alkene and hydroxyalkane sulfonates, and disulfonates, as they are obtained, for example, from C₁₂₋₁₈ monoolefins having a terminal or internal double bond by way of sulfonation with gaseous sulfur trioxide and subsequent alkaline or acid hydrolysis of the sulfonation products. Alkylbenzene sulfonates may be alkylbenzene sulfonates having a linear or branched, saturated or unsaturated C₆₋₂₂ alkyl, such as a C₈₋₁₈ alkyl, for example a C₉₋₁₄ alkyl, i.e. C₁₀₋₁₃ alkyl radicals. They are used as alkali metal and/or alkaline earth metal salts, in particular sodium, potassium, magnesium and/or calcium salts, as well as ammonium salts or mono-, di- or trialkanolammonium salts, such as mono-, di- or triethanol- and/or isopropanol ammonium salts, in particular mono-, di- or triethanol ammonium salts but also used as alkylbenzene sulfonic acid together with the corresponding alkali metal or alkaline earth metal hydroxide and/or ammonia or mono-, di- or trialkanolamine. The esters of 2-sulfofatty acids (ester sulfonates), for example the 2-sulfonated methyl esters of hydrogenated coconut fatty acids, palm kernel fatty acids or tallow fatty acids are suitable as well.

They are used in the form of the alkali metal- and alkaline-earth metal salts thereof, in particular sodium, potassium and magnesium salts, and ammonium- and mono-, di-, tri- or tetra-alkyl ammonium salts, and, in the case of the sulfonates, also in the form of the acid thereof, such as dodecylbenzene sulfonic acid, C₁₀-C₁₃ alkylbenzene sulfonic acid and/or C₁₀-C₁₄ alkylbenzene sulfonic acid. When using sulfonic acid, this is usually in situ with one or more corresponding bases, for example alkali metal and alkaline earth metal hydroxides, especially sodium, potassium and magnesium hydroxide, and ammonia or mono-, di-, tri- or tetraalkylamine, which is partially or completely neutralized to the aforementioned salts depending on the pH value of the composition.

The compositions contain one or more anionic surfactants in a quantity, based on the composition, from 0 to 45 wt. %, such as from 0.01 to 44 wt. %, for example from 0.1 to 43 wt. %, i.e. from 1 to 40 wt. %, such as from 2 to 35 wt. %, for example from 3 to 30 wt. %, i.e. from 4 to 25 wt. %, such as 20 wt. %, 10 wt. % or 5 wt. %. In an embodiment, the surfactant system is based on anionic surfactant(s), i.e. the proportion of anionic surfactant(s) is at least half of the total amount of surfactants, in particular even more than half of the total amount of surfactants. Furthermore, all upper and lower limits of the surfactant concentrations disclosed in this section may be combined.

In an embodiment, anionic surfactants, such as linear or branched, secondary alkyl sulfonates, such as having up to 20 carbon atoms, are contained in a quantity from 0.01 to 45 wt. %, such as from 0.1 to 30 wt. %, for example from 0.5 to 15 wt. %, i.e. from 1 to 10 wt. %, based on the total weight of the liquid, aqueous composition.

Secondary alkyl sulfonate here refers to linear or branched compounds whose sulfonic acid group (—SO₂—OH) or sulfonate group (—SO₂—O⁻) is bonded to a carbon atom which is bonded to two further carbon atoms. The hydrocarbon chain is linear or branched, such as having up to 20 carbon atoms.

Suitable cationic surfactants are, inter alia, the quaternary ammonium compounds of formula (Rⁱ)(Rⁱⁱ)(Rⁱⁱⁱ)(R^{iv})N⁺X⁻ in which Rⁱ to R^{iv} denote four identical or different, and in particular two long-chain and two short-chain alkyl radicals, and X⁻ denotes an anion, in particular a halide ion, for example didecyl dimethyl ammonium chloride, alkyl benzyl didecyl ammonium chloride, alkyl dimethyl hydroxyethyl ammonium chloride, bromide or methyl sulfate, especially with C₁₂-alkyl and the mixtures thereof. The compositions contain cationic surfactants in quantities, based on the composition, from 0 to 10 wt. %, such as 0.01 to 5 wt. %, and in particular 0.1 to 3 wt. %.

Suitable amphoteric surfactants (zwitterionic surfactants) are, for example, betaines, alkyl amido alkylamines, alkyl-substituted amino acids, acylated amino acids or biosurfactants of which the betaines are within the scope of the teaching.

Suitable betaines are the alkyl betaines, the alkyl amido betaines, the imidazolinium betaines, the sulfobetaines (INCI sultaines) and the phosphobetaines that satisfy the formula (R^{A})(R^{B})(R^{C})N⁺CH₂COO⁻ in which R^{A} is an alkyl radical having 8 to 25, such as 10 to 21 carbon atoms, optionally interrupted by hetero atoms or heteroatom groups, and R^{B} and R^{C} are identical or different alkyl radicals having 1 to 3 carbon atoms, in particular C₁₀-C₁₈ alkyl dimethyl carboxymethyl betaine and C₁₁-C₁₇ alkyl amidopropyl dimethyl carboxymethyl betaine, or formula A,

R^{I}—[CO—X—CH₂)ₙ]ₓ—N⁺(R^{II})(R^{III})—(CH₂)ₘ—[CH(OH)—CH₂]_{y}—Y⁻ (A),

in which
R^{I} is a saturated or unsaturated C₆₋₂₂ alkyl radical, such as C₈₋₁₈ alkyl radical, in particular a saturated C₁₀₋₁₆ alkyl radical, for example a saturated C₁₂₋₁₄ alkyl radical,
X is NH, NR^{IV} with the C₁₋₄ alkyl radical R^{IV}, O or S,
n is a number from 1 to 10, such as 2 to 5, in particular 3,
x is 0 or 1, such as 1,
R^{II} and R^{III} is independently of one another, a C₁₋₄ alkyl radical, optionally hydroxy-substituted, such as a hydroxyethyl radical, but in particular a methyl radical,
m is a number from 1 to 4, such as 1, 2 or, in particular 3,
y is 0 or 1 and
Y is COO, SO₃, OPO(OR^{V})O or P(O)(OR^{V})O, wherein R^{V} is a hydrogen atom H or a C₁₋₄ alkyl radical.

The alkyl and alkylamido betaines, betaines of formula A having a carboxylate group (Y⁻═COO⁻), are also called carbobetaines.

Non-limiting amphoteric surfactants are the alkylbetaines of the formula A1, the alkylamidobetaines of the formula A2, the sulfobetaines of the formula A3 and the amidosulfobetaines of the formula A4,

R^{I}—N⁺(CH₃)₂—CH₂COO⁻ (A1)

R^{I}—CO—NH—(CH₂)₃—N⁺(CH₃)₂—CH₂COO⁻ (A2)

R^{I}—N⁺(CH₃)₂—CH₂CH(OH)CH₂SO₃⁻ (A3)

R^{I}—CO—NH—(CH₂)₃—N⁺(CH₃)₂—CH₂CH(OH)CH₂SO₃⁻ (A4)

in which R^{I} has the same meaning as in formula A.

Particularly non-limiting amphoteric surfactants are the carbobetaines, such as carbobetaines of the formula A1 and A2, for example the alkylamidobetaines of the formula A2. Examples of suitable betaines and sulfobetaines are the following compounds named in accordance with the INCI: Almond amidopropyl betaine, apricot amidopropyl betaine, avocado amidopropyl betaine, babassuamidopropyl betaine, behenamidopropyl betaine, behenyl betaine, betaine, canolamidopropyl betaine, caprylic capramidopropyl betaine, carnitine, cetyl betaine, cocamidoethyl betaine, cocamidopropyl betaine, cocamidopropyl hydroxysultaine, coco betaine, coco hydroxysultaine, coco/oleamidopropyl betaine, coco-sultaine, decyl betaine, dihydroxyethyl oleyl glycinate, dihydroxyethyl soy glycinate, dihydroxyethyl stearyl glycinate, dihydroxyethyl tallow glycinate, dimethicone propyl PG betaine, erucamidopropyl hydroxysultaine, hydrogenated tallow betaine, isostearamidopropyl betaine, lauramidopropyl betaine, lauryl betaine, lauryl hydroxysultaine, lauryl sultaine, milk amidopropyl betaine, minkamidopropyl betaine, myristamidopropyl betaine, myristyl betaine, oleamidopropyl betaine, oleamidopropyl hydroxysultaine, oleyl betaine, olivamidopropyl betaine, palm amidopropyl betaine, palmitamidopropyl betaine, palmitoylcarnitine, palm kernel amidopropyl betaine, polytetrafluoroethylene acetoxypropyl betaine, ricinoleamidopropyl betaine, sesamidopropyl betaine, soy amidopropyl betaine, stearamidopropyl betaine, stearyl betaine, tallowamidopropyl betaine, tallowamidopropyl hydroxysultaine, tallow betaine, tallow dihydroxyethyl betaine, undecylenamidopropyl betaine and wheat germamidopropyl betaine. A non-limiting amphoteric surfactant is cocamidopropyl betaine (cocoamidopropyl betaine). A particularly non-limiting amphoteric surfactant is caprylic/capramidopropyl betaine (CAB).

The alkylamidoalkylamines (INCI: alkylamido alkylamines) are amphoteric surfactants of the formula B,

R^{VI}—CO—NR^{VII}—(CH₂)ᵢ—N(R^{VIII})—(CH₂CH₂O)ⱼ—(CH₂)ₖ—[CH(OH)]ₗ—CH₂—Z—OM (B)

in which
R^{VI} is a saturated or unsaturated C₆₋₂₂ alkyl radical, such as a C₈₋₁₈ alkyl radical, in particular a saturated C₁₀₋₁₆ alkyl radical, for example a saturated C₁₂₋₁₄ alkyl radical,
R^{VII} is a hydrogen atom H or a C₁₋₄ alkyl radical, such as H,
i is a number from 1 to 10, such as 2 to 5, in particular 2 or 3,
R^{VIII} is a hydrogen atom H or CH₂COOM (to M see below),
j is a number from 1 to 4, for example 1 or 2, in particular 1,
k is a number from 0 to 4, such as 0 or 1,
l is 0 or 1, where k=1 when l=1,
Z is CO, SO₂, OPO(OR¹²) or P(O)(OR¹²), with R¹² being a C₁₋₄ alkyl radial or M (see below), and
M is a hydrogen, an alkali metal, an alkaline-earth metal or a protonated alkanolamine, for example protonated mono-, di- or triethanolamine.
   Non-limiting representatives satisfy the formulas B1 to B4,

R^{VI}—CO—NH—(CH₂)₂—N(R^{VIII})—CH₂CH₂O—CH₂—COOM (B1)

R^{VI}—CO—NH—(CH₂)₂—N(R^{VIII})—CH₂CH₂O—CH₂CH₂—COOM (B2)

R^{VI}—CO—NH—(CH₂)₂—N(R^{VIII})—CH₂CH₂O—CH₂CH(OH)CH₂—SO₃M (B3)

R^{VI}—CO—NH—(CH₂)₂—N(R^{VIII})—CH₂CH₂O—CH₂CH(OH)CH₂—OPO₃HM (B4)

in which R^{VI}, R^{VIII} and M have the same meaning as in formula B.

Examples of alkylamidoalkylamines are the following compounds as named in accordance with the INCI: Cocoamphodipropionic acid, cocobetainamido amphopropionate, DEA cocoamphodipropionate, disodium caproamphodiacetate, disodium caproamphodipropionate, disodium capryloamphodiacetate, disodium capryloamphodipropionate, disodium cocoamphocarboxyethylhydroxypropylsulfonate, disodium cocoamphodiacetate, disodium cocoamphodipropionate, disodium isostearoamphodiacetate, disodium isostearoamphodipropionate, disodium laureth-5 carboxyamphodiacetate, disodium lauroamphodiacetate, disodium lauroamphodipropionate, disodium oleoamphodipropionate, disodium PPG-2-isodeceth-7 carboxyamphodiacetate, disodium stearoamphodiacetate, disodium tallowamphodiacetate, disodium wheat germ amphodiacetate, lauroamphodipropionic acid, quaternium-85, sodium caproamphoacetate, sodium caproamphohydroxypropylsulfonate, sodium caproamphopropionate, sodium capryloamphoacetate, sodium capryloamphohydroxypropylsulfonate, sodium capryloamphopropionate, sodium cocoamphoacetate, sodium cocoamphohydroxypropylsulfonate, sodium cocoamphopropionate, sodium comamphopropionate, sodium isostearoamphoacetate, sodium isostearoamphopropionate, sodium lauroamphoacetate, sodium lauroamphohydroxypropylsulfonate, sodium lauroampho PG-acetate phosphate, sodium lauroamphopropionate, sodium myristoamphoacetate, sodium oleoamphoacetate, sodium oleoamphohydroxypropylsulfonate, sodium oleoamphopropionate, sodium ricinoleoamphoacetate, sodium stearoamphoacetate, sodium stearoamphohydroxypropylsulfonate, sodium stearoamphopropionate, sodium tallamphopropionate, sodium tallow amphoacetate, sodium undecylenoamphoacetate, sodium undecylenoamphopropionate, sodium wheat germ amphoacetate and trisodium lauroampho PG acetate chloride phosphate.

Non-limiting alkyl-substituted amino acids (INCI alkyl-substituted amino acids) are monoalkyl-substituted amino acids according to formula C,

R^{IX}—NH—CH(R^{X})—(CH₂)ᵤCOOM′ (C)

in which
R^{IX} is a saturated or unsaturated C₆₋₂₂ alkyl radical, such as a C₈₋₁₈ alkyl radical, in particular a saturated C₁₀₋₁₆ alkyl radical, for example a saturated C₁₂₋₁₄ alkyl radical,
R^{X} is a hydrogen atom H or a C₁₋₄ alkyl radical, such as H,
u is a number from 0 to 4, such as 0 or 1, in particular 1, and
M′ is a hydrogen, an alkali metal, an alkaline-earth metal or a protonated alkanolamine, for example protonated mono-, di- or triethanolamine,
   alkyl-substituted imino acids according to formula D,

R^{XI}—N—[(CH₂)ᵥ—COOM″]₂ (D)

in which
R^{XI} is a saturated or unsaturated C₆₋₂₂ alkyl radical, such as a C₈₋₁₈ alkyl radical, in particular a saturated C₁₀₋₁₆ alkyl radical, for example a saturated C₁₂₋₁₄ alkyl radical,
v is a number from 1 to 5, such as 2 or 3, in particular 2, and
M″ is a hydrogen, an alkali metal, an alkaline-earth metal or a protonated alkanolamine, for example protonated mono-, di- or triethanolamine, where M″ in the two carboxy groups may have the same or two different meanings, for example, hydrogen and sodium or sodium in both cases,
   and mono- or dialkyl-substituted natural amino acids according to formula E,

R^{XII}—N(R^{XIII})—CH(R^{XIV})—COOM′″ (E)

in which
R^{XII} is a saturated or unsaturated C₆₋₂₂ alkyl radical, such as a C₈₋₁₈ alkyl radical, in particular a saturated C₁₀₋₁₆ alkyl radical, for example a saturated C₁₂₋₁₄ alkyl radical,
R^{XIII} is a hydrogen atom or a C₁₋₄ alkyl radical, optionally hydroxyl or amine-substituted, for example a methyl, ethyl, hydroxyethyl or aminopropyl radical,
R^{XIV} is the radical of one of the 20 natural α-amino acids H₂NCH(R^{XIV})COOH, and
M′″ is a hydrogen, an alkali metal, an alkaline-earth metal or a protonated alkanolamine, for example protonated mono-, di- or triethanolamine.

Particularly non-limiting alkyl-substituted amino acids are the aminopropionates according to formula C1,

R^{IX}—NH—CH₂CH₂COOM′ (C1)

in which R^{IX} and M′ have the same meaning as in formula C.

Exemplary alkyl-substituted amino acids are the following compounds named according to INCI: Aminopropyl laurylglutamine, cocaminobutyric acid, cocaminopropionic acid, DEA lauraminopropionate, disodium cocaminopropyl iminodiacetate, disodium cicarboxyethyl cocopropylenediamine, disodium lauriminodipropionate, disodium steariminodipropionate, disodium tallow iminodipropionate, lauraminopropionic acid, lauryl aminopropylglycine, lauryl diethylenediaminoglycine, myristaminopropionic acid, sodium C12-15 alkoxypropyl iminodipropionate, sodium docaminopropionate, sodium lauraminopropionate, sodium lauriminodipropionate, sodium lauroyl methylaminopropionate, TEA lauraminopropionate and TEA myristaminopropionate.

Acylated amino acids are amino acids, in particular the 20 natural α-amino acids which carry the acyl radical R^{XV}CO of a saturated or unsaturated fatty acid R^{XV}COOH on the amino nitrogen atom, wherein R^{XV} is a saturated or unsaturated C₆₋₂₂ alkyl radical, such as a C₈₋₁₈ alkyl radical, in particular a saturated C₁₀₋₁₆ alkyl radical, for example a saturated C₁₂₋₁₄ alkyl radical. The acylated amino acids can also be used as the alkali metal salt, alkaline-earth metal salt or alkanol ammonium salt, for example mono-, di- or triethanol ammonium salt. Exemplary acylated amino acids are the acyl derivatives summarized according to INCI under amino acids, e.g. sodium cocoyl glutamate, lauroyl glutamic acid, capryloyl glycine or myristoyl methylalanine.

The compositions may contain one or more amphoteric surfactants, in particular alkylamido betaines, in amounts, based on the composition, from 0 to 15 wt. %, such as from 0.1 to 10 wt. %, for example from 1 to 8 wt. %, i.e. from 2 to 6 wt. %, in particular from 3 to 5 wt. %, for example 4 wt. %.

Suitable nonionic surfactants are, for example, C₆-C₂₂ alkyl alcohol polyglycol ethers, alkyl polyglycosides and nitrogen-containing surfactants or also sulfosuccinic acid di-C₁-C₁₂ alkyl esters or mixtures thereof, in particular of the first two. The compositions may contain nonionic surfactants in quantities based on the total weight of the composition, usually from 0 to 30 wt. %, such as from 0.1 to 25 wt. %, for example from 1 to 20 wt. %, i.e. from 2 to 15 wt. %, such as from 3 to 10 wt. %, for example 4 or 9 wt. %.

In an embodiment, the at least one surfactant comprises a nonionic surfactant, such as a nonionic surfactant from the group of the alkyl sulfates and alkyl ether sulfates, and/or wherein the at least one surfactant is present in quantities from 0.01 to 45 wt. %, such as from 0.1 to 30 wt. %, for example from 0.5 to 15 wt. %, i.e. from 1 to 10 wt. %, based on the total weight of the liquid, aqueous composition.

C₆-C₂₂ alkyl alcohol polypropyleneglycol/polyethyleneglycol ethers are known nonionic surfactants. They can be described with the formula I

RⁱO—(CH₂CH(CH₃)O)ₚ(CH₂CH₂O)ₑ—H

in which Rⁱ represents a linear or branched aliphatic alkyl and/or alkenyl radical having 6 to 22 carbon atoms, such as 8 to 18 carbon atoms, for example 10 to 16 carbon atoms, and p represents 0 or numbers from 1 to 3, and e numbers from 1 to 20. The C₆-C₂₂ alkyl alcohol polyglycol ethers of the formula I can be obtained by attaching propylene oxide and/or ethylene oxide to alkyl alcohols, such as to oxo alcohols, branched-chain primary alcohols obtainable by the oxo synthesis, or fatty alcohols, in particular to fatty alcohols. Typical examples are polyglycol ethers in which Rⁱ denotes an alkyl radical having 8 to 18 carbon atoms, p denotes 0 to 2, and e denotes numbers from 2 to 7. Non-limiting representatives are, for example, C₁₀-C₁₄ fatty alcohol+1-PO+6-EO ether (p=1, e=6), C₁₂-C₁₆ fatty alcohol+5.5-EO (p=0, e=5.5), C₁₂-C₁₈ fatty alcohol+7-EO-ether (p=0, e=7) and isodecanol+6-EO (R¹=isomeric mixture of C₁₀ oxo alcohol radicals, p=0, e=6) and their mixtures. In particular mixtures, at least one representative of the formula I with a linear alkyl radical R¹ is combined with at least one representative of formula I with a branched alkyl radical R¹, for example C₁₂-C₁₆ fatty alcohol+5.5-EO and isodecanol+6-EO. The linear alkyl radical may include more carbon atoms than the branched alkyl radical. Particularly non-limiting embodiments include C₈ fatty alcohol+1.2-PO+8.4-EO, C₈₋₁₀-fatty alcohol+5-EO, C₁₂₋₁₄ fatty alcohol+6-EO and C₁₂₋₁₄-fatty alcohol+3-EO and their mixtures.

It is also possible to use end-capped C₆-C₂₂ alkyl alcohol polyglycol ethers, i.e. compounds in which the free OH group is etherified in the formula I. The end-capped C₆₋₂₂ alkyl alcohol polyglycol ethers can be obtained with appropriate methods of preparative organic chemistry. C₆₋₂₂ alkyl alcohol polyglycol ethers are reacted with alkyl halides, in particular butyl or benzyl chloride in the presence of bases. Typical examples are mixed ethers from formula I, in which Rⁱ represents a technical fatty alcohol radical, such as a C₁₂₋₁₄-coconut alkyl radical, p represents 0, and e represents 5 to 10, which are capped with a butyl group.

The alkyl radical or alkenyl radical Rⁱⁱ (formula II) can be derived from primary alcohols having 8 to 22, such as 8 to 14, carbon atoms. Typical examples include caproic alcohol, caprylic alcohol, capric alcohol and undecyl alcohol as well as the industrial mixtures thereof as obtained, for example, in the course of the hydrogenation of industrial fatty acid methyl esters or in the course of the hydrogenation of aldehydes in the ROELEN oxosynthesis reaction. In non-limiting embodiments, the alkyl or alkenyl radical Rⁱⁱ is, however, derived from lauryl alcohol, myristyl alcohol, cetyl alcohol, palmoleyl alcohol, stearyl alcohol, isostearyl alcohol or oleyl alcohol. Further examples include elaidyl alcohol, petroselinyl alcohol, arachidyl alcohol, gadoleyl alcohol, behenyl alcohol, erucyl alcohol and the technical mixtures thereof.

Examples of suitable nitrogen-containing nonionic surfactants are amine oxides, polyhydroxy fatty acid amides, for example glucamides, and ethoxylates of alkylamines, vicinal diols and/or carboxylic acid amides, which have alkyl radicals with 10 to 22 C atoms, such as 12 to 18 C atoms. The degree of ethoxylation of these compounds is generally between 1 and 20, such as between 3 and 10. Ethanolamide derivatives of alkanoic acids having 8 to 22 C atoms, for example 12 to 16 C atoms, may be used. Particularly suitable compounds include lauric acid, myristic acid and palmitic acid monoethanolamides.

Amine oxides that are suitable include alkyl amine oxides, in particular alkyl dimethyl amine oxides, alkyl amido amine oxides, and alkoxy alkyl amine oxides. Non-limiting amine oxides satisfy the formula R¹R²R³N⁺—O⁻′ in which R¹ is a saturated or unsaturated C₆₋₂₂-alkyl radical, such as C₈₋₁₈-alkyl radical, for example a saturated C₁₀₋₁₆-alkyl radical, for example, a saturated C₁₂₋₁₄-alkyl radical in the alkylamido aminoxides, which is bonded via a carbonyl amidoalkyl group —CO—NH—(CH₂)_{z}— and in the alkoxy alkylamine oxides via an oxoalkylene group —O—(CH₂)_{z}— to the nitrogen atom N, with z being a number from 1 to 10, such as 2 to 5, in particular 3, and R² and R³ being independent of one another, an optionally hydroxy-substituted C₁₋₄ alkyl radical, for example a hydroxyethyl radical, in particular a methyl radical.

Examples of suitable amine oxides are the following compounds as named in accordance with the INCI: Almond amidopropylamine oxide, babassuamidopropylamine oxide, behenamine oxide, cocamidopropyl amine oxide, cocamidopropylamine oxide, cocamine oxide, coco-morpholine oxide, decylamine oxide, decyltetradecylamine oxide, diaminopyrimidine oxide, dihydroxyethyl C₈₋₁₀ alkoxypropylamine oxide, dihydroxyethyl C₉₋₁₁ alkoxypropylamine oxide, dihydroxyethyl C₁₂₋₁₅ alkoxypropylamine oxide, dihydroxyethyl cocamine oxide, dihydroxyethyl lauramine oxide, dihydroxyethyl stearamine oxide, dihydroxyethyl tallowamine oxide, hydrogenated palm kernel amine oxide, hydrogenated tallowamine oxide, hydroxyethyl hydroxypropyl C₁₂₋₁₅ alkoxypropylamine oxide, isostearamidopropylamine oxide, isostearamidopropyl morpholine oxide, lauramidopropylamine oxide, lauramine oxide, methyl morpholine oxide, milk amidopropyl amine oxide, minkamidopropylamine oxide, myristamidopropylamine oxide, myristamine oxide, myristyl/cetyl amine oxide, oleamidopropylamine oxide, oleamine oxide, olivamidopropylamine oxide, palmitamidopropylamine oxide, palmitamine oxide, PEG-3 lauramine oxide, potassium dihydroxyethyl cocamine oxide phosphate, potassium trisphosphonomethylamine oxide, sesamidopropylamine oxide, soyamidopropylamine oxide, stearamidopropylamine oxide, stearamine oxide, tallowamidopropylamine oxide, tallowamine oxide, undecylenamidopropylamine oxide and wheat germ amidopropylamine oxide. Non-limiting amine oxide(s) is/are, for example, cocamine oxides (N-cocoalkyl-N,N-dimethylamine oxide), dihydroxyethyl tallowamine oxides (N-tallowalkyl-N,N-dihydroxyethylamine oxide) and/or cocamidopropylamine oxides (cocoamidopropylamine oxide), in particular cocamidopropylamine oxides.

In non-limiting embodiments, the liquid, aqueous composition may contain at least one complexing agent. Complexing agents are also known by the name of chelating agents or sequestering agents. Typically, a complexing agent can bind metal ions to prevent them from reacting with other components of a composition. For example, they may be added to detergent or cleaning compositions to complex Ca and Mg ions to soften the water. Other complexing agents may contribute to the washing or cleaning power as well.

Suitable complexing agents are, for example, condensed phosphates, phosphonates, and/or aminocarboxylic acids.

Examples of condensed phosphates include, but are not limited to, sodium and potassium orthophosphate, sodium and potassium pyrophosphate, sodium tripolyphosphate, and sodium hexametaphosphate.

Examples of phosphonic acids, phosphonates or derivatives thereof include 2-phosphonobutane-1,2,4-tricarboxylic acid (PBTC), 1-hydroxyethane-(1,1-diphosphonic acid) (HEDP), aminotrimethylenephosphonic acid (ATMP), 2-hydroxyethyliminobis(methylenephosphonic acid), diethylenetriaminepenta(methylenephosphonic acid) (DTPMP), ethylenediaminetetra(methylenephosphonic acid) (EDTMP), hexamethylene diamine(tetramethylenephosphonic acid), bis(hexamethylene)triamine(pentamethylenephosphonic acid), phosphoric acid or suitable salts thereof, without being limited thereto.

A non-limiting combination of phosphonic acids, phosphonates or derivatives thereof is amino trimethylene phosphonic acid (ATMP) and diethylenetriaminepenta(methylenephosphonic acid) (DTPMP), or a suitable salt thereof.

In an embodiment, the composition contains 1-hydroxyethane-(1,1-diphosphonic acid) (HEDP) or a suitable salt thereof.

In one embodiment, the liquid, aqueous composition is essentially free of phosphorus-containing compounds.

In another embodiment, the liquid, aqueous composition is substantially free of phosphonate complexing agent.

In a further embodiment, the liquid, aqueous composition is substantially free of phosphorus-containing complexing agent.

Suitable aminocarboxylic acid materials containing little or no NTA include, but are not limited to, N-hydroxyethylaminodiacetic acid, ethylenediaminetetraacetic acid (EDTA), hydroxyethylenediaminetetraacetic acid, diethylenetriaminepentaacetic acid (DTPA), N-hydroxyethylethylenediaminetriacetic acid (HEDTA), methylglycinediacetic acid (MGDA), glutamic acid-N,N-diacetic acid (GLDA), ethylenediamine succinylic acid (EDDS), 2-hydroxyethyliminodiacetic acid (HEIDA), iminodisuccinic acid (IDS), 3-hydroxy-2-2′-iminodisuccinic acid (HIDS) and other similar acids or salts thereof having an amino group with a carboxylic acid substituent.

In an embodiment, however, the composition is substantially free of aminocarboxylic acids.

In non-limiting embodiments, the at least one complexing agent which can be used in the liquid, aqueous composition comprises a phosphonic acid, a derivative thereof or a suitable salt thereof, wherein the phosphonic acid is selected from the group consisting of 1-hydroxyethane-(1,1-diphosphonic acid) (HEDP), amino trimethylene phosphonic acid (ATMP), diethylenetriaminepenta(methylenephosphonic acid) (DTPMP), ethylenediaminetetra(methylenephosphonic acid) (EDTMP), hexamethylenediamine(tetramethylenephosphonic acid), 2-phosphonobutane-1,2,4-tricarboxylic acid (PBTC), bis(hexamethylene)triamine(pentamethylene phosphonic acid) and phosphoric acid or a salt thereof, wherein the phosphonic acid is a diphosphonic acid, a derivative thereof or a salt thereof, such as 1-hydroxyethane-(1,1-diphosphonic acid) (HEDP) or a suitable salt thereof.

The at least one complexing agent is contained in quantities from 0.01 to 50 wt. %, such as from 0.1 to 30 wt. %, for example from 0.5 to 15 wt. %, i.e. from 1 to 10 wt. %, based on the total weight of the liquid, aqueous composition.

Furthermore, the liquid, aqueous composition may comprise at least one polymer. Examples of suitable polymers are phosphorus-free water-conditioning polymers such as polycarboxylic acids or suitable salts thereof, for example polyacrylic acid, maleic acid, maleic/olefin copolymers, sulfonated copolymers or terpolymers, acrylic/maleic copolymers, polymethacrylic acid, acrylic acid-methacrylic acid copolymers, hydrolyzed polyacrylamides, hydrolyzed polymethacrylamides, hydrolyzed acrylonitriles, hydrolyzed methacrylonitriles, and hydrolyzed acrylonitrile-methacrylonitrile copolymers.

Non-limiting polymers have a weight-averaged molecular weight from 10,000 g/mol to 1,000,000 g/mol, such as from 100,000 to 500,000 g/mol, for example from 150,000 g/mol, i.e. to 250,000 g/mol. The weight-averaged molecular weight is determined by GPC using polystyrene standards.

In an embodiment, the liquid, aqueous composition may comprise at least one polymer in quantities from 0.01 to 30 wt. %, such as from 0.1 to 20 wt. %, for example from 0.5 to 15 wt. %. %, i.e. from 1 to 10 wt. %, based on the total weight of the liquid, aqueous composition.

The liquid aqueous compositions may further comprise at least one enzyme, optionally in combination with other enzymes, in order to ensure adequate cleaning power, for example on dried-on and encrusted food and dirt residues.

Enzymes that may be used are amylases, proteases, hemicellulases, peroxidases and/or lipases.

Amylases may be added to remove starch and glycogen. According to non-limiting embodiments, alpha, beta and gamma amylases (α, β, γ-amylases), as well as glucoamylases and maltogenic amylases are usable. Suitable amylases are commercially available, for example, under the names Duramyl®, Termamyl®, Fungamyl® and BAN® (Novo Nordisk), as well as Maxamyl®, or Purafect® OxAm. The amylases may be derived from any sources, such as bacteria, fungi, pancreas glands of animal origin, germinated cereals, yeasts, etc. Genetically modified amylases may also be used in the compositions.

The amylase enzymes may be present in the compositions in quantities from 0.00001 to 5 wt. %, such as from 0.0001% to approx. 1 wt. %, for example from 0.0005 to approx. 0.5 wt. % and in particular from 0.01 to about 0.4 wt. %.

In a non-limiting embodiment, the added amylase enzymes are present in quantities from 0.001 to 0.5 wt. %, such as from 0.001 to 0.4 wt. %, for example from 0.01 to 0.35 wt. %. %, i.e. from 0.01 to 0.2 wt. %. The quantities provided are based on the total weight of the liquid, aqueous composition.

In addition to amylases, proteases for splitting proteins and peptide residues may also be added to the compositions. Proteases are particularly suitable for the hydrolytic splitting and removal of protein residues, in particular dried-on protein residues.

Proteases, which are suitable, are proteinases (endopeptidases) and peptidases (exopeptidases). Useful proteases may be of a plant, animal, bacterial and/or fungal origin. Suitable proteases are, in particular, serine, cysteine, aspartate and metalloproteases. Genetically modified proteases may also be used in the compositions.

Useful proteases are commercially available under the names Alcalase®, BLAP®, Durazym®, Esperase®, Everlase®, Maxapem®, Maxatase®, Optimase Purafect®OxP or Savinase®.

Typically, proteases are used in the range from 0.00001 to 1.5 wt. %, such as in the range from 0.0001 to 0.75 wt. %, based on the total weight of the composition.

Furthermore, lipases may be used in compositions for the removal of firmly adhering fatty stains. Lipases are therefore a bio-alternative to surfactants and may support the cleaning action of the surfactants in the range from 0.0001 to 1 wt. %. Suitable lipases can be obtained from plants (for example, types of castor oil plants), microorganisms and animal sources, such as pancreatic lipases. Commercially available lipases are, for example, Lipolase®, Lipomax®, Lipozym® and Lumafast®.

The abovementioned enzymes may be added to the compositions individually or in any desired combinations with one another. Amylases, in particular alpha-amylases and proteases, may be used herein.

Optionally, the enzymes that can be added may be combined with any other enzymes in order to further improve the cleaning power of the composition. Further enzymes, which are suitable, are cellulases, hemicellulases, peroxidases, reductases, oxidases, ligninases, cutinases, pectinases, xylanases, phenol oxidases, lipoxygenases, tannases, pentosanases, malanases. Glucanases, arabinosidases and any mixtures of these enzymes.

In an embodiment, the at least one enzyme in the composition is used in quantities from 0.00001 to 5 wt. %, such as from 0.0001 to 1 wt. %, for example from 0.01 to 0.4 wt. %, based on the total weight of the liquid, aqueous composition.

Amylases can be stabilized by adding calcium chloride ions. Boric acid/borates/perborates, in combination with glycerin and/or PEG as well as nonionic surfactants with available hydroxyl groups, are further suitable stabilizers.

In a non-limiting embodiment, therefore, calcium chloride, such as in the form of the dihydrate (CaCl₂×2 H₂O), is added to the compositions.

The amount of calcium chloride added is 0.01 to 2 wt. %, such as 0.05 to 1 wt. %, for example 0.08 to 1 wt. %, and i.e. approx. 0.1 wt. % based on the total weight of the liquid, aqueous composition.

It has also surprisingly been found that the at least one carbohydrate or a derivative thereof, which has an acid value of <10 mg KOH/g and in which the basic carbohydrate structure has a molecular mass of 140 to 540 g/mol, is capable of stabilizing the added enzymes, i.e. to maintain them in an enzymatically active form over a longer period of time.

In addition to the components mentioned, the composition may contain further auxiliary agents that are common in such detergents. These include, in particular, stain releasing agents, solubilizers, hydrotropes (e.g. sodium cumene sulphonate, octylsulfate, butylglucoside, butylglycol), builder substances, emulsifiers (e.g. gallus soap), thickeners, gloss-drying additives, cleaning boosters, antimicrobial agents or disinfectants, antistatic agents, preservatives (for example glutaraldehyde), bleaching systems, perfumes, fragrances and dyes, as well as opacifiers or even skin protection agents, as described in EP-A-522 556. The amount of additives of this type is usually not greater than 12 wt. % in the liquid, aqueous composition. The lower limit of their use depends on the type of auxiliary agent or additive and may be as low as 0.001 wt. % or less for dyes. The auxiliary agents and additives are between 0.01 and 7 wt. %, in particular 0.1 and 4 wt. %.

The composition may contain one or more builders.

If the builder is to act as a pH stabilizing buffer, alkali metal and alkaline earth-metal carbonates and bicarbonates may be used, such as sodium carbonate (soda), for example together with citric acid or citrate, optionally produced in situ from citric acid and hydroxide, e.g. sodium or potassium citrate, i.e. together with the above-described mixture of citric acid or citrate.

In the context, the citrates may be the salts of the triply deprotonated citric acid. But, the mono- and dihydrogen citrates can also be used.

In a particular embodiment, the composition contains citric acid or citrate and magnesium chloride, in particular monoethanolammonium citrate and magnesium chloride.

The solvent in the liquid, aqueous compositions is water, but organic solvents may also be present in the liquid, aqueous composition and partially replace the water.

The term “aqueous composition” includes both water and mixtures of water with water-soluble organic solvents, for example alcohols, with water being the solvent.

Suitable organic solvents are, for example, saturated or unsaturated, such as saturated, branched or unbranched C₁₋₂₀-hydrocarbons, for example C₂₋₁₅-hydrocarbons with one or more hydroxy groups, i.e. one hydroxy group and optionally one or more ether functions C—O—C, i.e. the carbon atom chain interrupting oxygen atoms.

Non-limiting solvents are C₁₋₆-alcohols, in particular ethanol, n-propanol or isopropanol, and also the C₂₋₆-alkylene glycols and poly C₂₋₃-alkylene glycol ethers optionally unilaterally etherified with a C₁₋₆-alkanol, having on average 1 to 9 identical or different, such as identical, alkylene glycol groups per molecule, in particular the poly-C2-3-alkylene glycol ethers having been one-sidedly etherified with a C₁₋₆-alkanol ether and having an average of 1 to 9, for example 2 to 3, ethylene or propylene glycol groups, for example PPG-2 methyl ether (dipropylene glycol monomethyl ether).

Examples of solvents are the following compounds as named in accordance with the INCI: Alcohol (ethanol), buteth-3, butoxy diglycol, butoxyethanol, butoxy isopropanol, butoxy propanol, n-butyl alcohol, t-butyl alcohol, butylene glycol, butyloctanol, diethylene glycol, dimethoxy diglycol, dimethyl ether, dipropylene glycol, ethoxydiglycol, ethoxyethanol, ethyl hexanediol, glycol, hexanediol, 1,2,6-hexanetriol, hexyl alcohol, hexylene glycol, isobutoxypropanol, isopentyldiol, isopropyl alcohol (isopropanol), 3-methoxybutanol, methoxy diglycol, methoxyethanol, methoxyisopropanol, methoxymethylbutanol, methoxy PEG-10, methylal, methyl alcohol, methyl hexyl ether, methylpropanediol, neopentyl glycol, PEG-4, PEG-6, PEG-7, PEG-8, PEG-9, PEG-6 methyl ether, pentylene glycol, PPG-7, PPG-2-buteth-3, PPG-2 butyl ether, PPG-3 butyl ether, PPG-2 methyl ether, PPG-3 methyl ether, PPG-2 propyl ether, propanediol, propyl alcohol (n-propanol), propylene glycol, propylene glycol butyl ether, Propylene glycol propyl ether, tetrahydrofurfuryl alcohol, trimethyl hexanol. Products with aliphatic or aromatic alcohols, for example, methanol, ethanol, n-propanol, n-butanol, tert-butanol or phenol, or carboxylic acids, for example, acetic or carbonic acid, etherified or esterified monomers or homopolymers or heteropolymers, in particular monomers and homodimers and trimers, C₂-C₄-alkylene glycols, are sold for example, under the trade name Dowanol® by the company Dow Chemical and under the trade names Arcosolv® and Arconate® by the company Arco Chemical, with their INCI name according to the International Dictionary of Cosmetic Ingredients of The Cosmetic, Toiletry, and Fragrance Association (CTFA), e.g. Butoxy diglycol (Dowanol® DB), methoxy diglycol (Dowanol® DM), PPG-2 methyl ether (Dowanol® DPM), PPG-2 methyl ether acetate (Dowanol® DPMA), PPG-2 butyl ether (Dowanol® DPnB), PPG-2 propyl ether (Dowanol® DPnP), butoxyethanol (Dowanol® EB), phenoxyethanol (Dowano/® EPh), methoxy isopropanol (Dowanol® PM), PPG-1 methyl ether acetates (Dowanol® PMA), butoxy isopropanol (Dowanol® PnB), propylene glycol propyl ether (Dowanol® PnP), phenoxy isopropanol (Dowanol® PPh), PPG-3 methyl ether (Dowanol® TPM) and PPG-3 butyl ether (Dowanol® TPnB), and ethoxy isopropanol (Arcosolv® PE), tert-butoxy isopropanol (Arcosolv® PTB), PPG-2 tert-butyl ether (Arcosolv® DPTB) and propylene carbonate (Arconate® PC), of which butoxy isopropanol (dipropylene glycol n-butyl ether, Dowanol® PnB) and especially PPG-2 methyl ether (dipropylene glycol methyl ether, Dowanol® DPM) may be used.

In a non-limiting embodiment, the compositions contain one or more hydrophobic components. The hydrophobic components not only improve the cleaning action against hydrophobic impurities such as greasy stains but also have a positive effect on the phase separation and their reversibility in multiphase compositions. Suitable hydrophobic components are, for example, dialkyl ethers having identical or different C₄- to C₁₄ alkyl radicals, in particular linear dioctyl ether; hydrocarbons having a boiling range from 100 to 300° C., in particular 140 to 280° C., e.g. aliphatic hydrocarbons having a boiling range from 145 to 200° C., isoparaffins having a boiling range from 200 to 260° C.; essential oils, especially limonene, and pine oil extracted from pine roots and stumps; and also mixtures of these hydrophobic components, in particular mixtures of two or three of said hydrophobic components. Non-limiting mixtures of hydrophobic components are mixtures of different dialkyl ethers, of dialkyl ethers and hydrocarbons, of dialkyl ethers and essential oils, of carbohydrates and essential oils, of dialkyl ethers and hydrocarbons and essential oils and mixtures thereof. The compositions may contain hydrophobic components in quantities, based on the composition, from 0 to 20 wt. %, such as 0.1 to 14 wt. %, for example 0.5 to 10 wt. %, and i.e. 0.8 to 7 wt. %.

If the compositions are formulated in multiphase form, they may contain one or more phase separation auxiliaries. Suitable phase separation aids are, in addition to citric acid or citrates, for example, the alkali metal and alkaline earth metal halides, in particular chlorides, and sulfates and nitrates, in particular sodium and potassium chloride and sulfate, and ammonium chloride and sulfate or mixtures thereof.

Such salts support as strong electrolytes, which increase ion strength, the phase separation by the salt effect. Sodium chloride has been found to be particularly effective here while sodium sulfate and magnesium sulfate in particular have less phase-separating effect. The compositions may contain phase separation aids in quantities, based on the composition, from 0 to 30 wt. %, such as from 1 to 20 wt. %, for example from 3 to 15 wt. %, i.e. from 5 to 12 wt. %.

To adjust the viscosity, the composition may contain one or more thickening agents, such as in quantities from 0.01 to 5 wt. %, for example from 0.05 to 2.5 wt. %, i.e. from 0.1 to 1 wt. %.

Suitable thickening agents are, for example, organic natural thickeners (agar-agar, carrageenan, tragacanth, arabic gum, alginates, pectins, polyoses, guar flour, locust bean gum, starch, dextrins, gelatin, casein), organic modified natural products (carboxymethylcellulose and other cellulose ethers, hydroxyethyl and propylcellulose and the like, core flour ethers), organic fully synthetic thickeners (polyacrylic and polymethacrylic compounds, vinyl polymers, polycarboxylic acids, polyethers, polyimines, polyamides) and inorganic thickeners (polysilicic acids, clay minerals such as montmorillonites, zeolites, silicas).

Examples of polyacrylic and polymethacrylic compounds include the high molecular weight homopolymers of acrylic acid crosslinked with a polyalkenyl polyether, in particular an allyl ether of pentaerythritol or propylene (INCI name according to the International Dictionary of Cosmetic Ingredients of The Cosmetic, Toiletry, and Fragrance Association (CTFA): carbomer), also referred to as carboxyvinyl polymers. Such polyacrylic acids are available, inter alia, from the company BF Goodrich under the trade name Carbopol®, e.g. Carbopol® 940 (molecular weight about 4,000,000 g/mol), Carbopol® 941 (molecular weight about 1,250,000 g/mol) or Carbopol® 934 (molecular weight about 3,000,000 g/mol). The following acrylic acid copolymers fall under this category as well: (i) copolymers of two or more monomers from the group of acrylic acid, methacrylic acid and their simple ester, such as formed with C₁₋₄ alkanols (INCI: acrylates copolymer), which include, for example, the copolymers of methacrylic acid, butyl acrylate and methyl methacrylate (CAS identification according to the Chemical Abstracts Service: 25035-69-2) or butyl acrylate and methyl methacrylate (CAS 25852-37-3) and which are available, for example, from Rohm & Haas under the trade names Aculyn® and Acusol®, for example the anionic non-associative polymers Aculyn® 33 (cross-linked), Acusol® 810 and Acusol® 830 (CAS 25852-37-3); (ii) cross-linked high-molecular-weight acrylic acid copolymers, which include for instance the copolymers of C10-30 alkyl acrylates cross-linked with an allyl ether of pentaerythritol with one or more monomers from the group of acrylic acid, methacrylic acid and their simple esters, such as formed by C₁₋₄ alkanols, (INCI acrylates/C10-30 alkyl acrylate crosspolymer) and which are available, for example, from BF Goodrich under the trade name Carbopol®, for example the hydrophobized Carbopol® ETD 2623 and Carbopol® 1382 (INCI: acrylates/C10-30 alkyl acrylate crosspolymer) and Carbopol® AQUA 30 (formerly Carbopol® EX 473). In addition to the thickening effect, these compositions in detergents may have other effects, such as graying protection.

In an embodiment, the polyacrylic and polymethacrylic compounds, which are suitable as thickeners, have an average molecular weight of >100,000 g/mol, such as of >500,000 g/mol.

Non-limiting thickening agents are polysaccharides and heteropolysaccharides, in particular polysaccharide gums, for example arabic gum, agar, alginates, carrageenans and their salts, guar, guar gum, tragacanth, gellan, ramsan, dextran or xanthan and their derivatives, for example propoxylated guar, and mixtures thereof. Other polysaccharide thickeners, such as starches or cellulose derivatives, may alternatively, such as but additionally be used in addition to a polysaccharide gum, for example starches of various origins and starch derivatives, for example hydroxyethyl starch, starch phosphate esters or starch acetates, or carboxymethyl cellulose or its sodium salt, methyl, ethyl, hydroxyethyl, hydroxypropyl, hydroxypropyl methyl or hydroxyethyl methyl cellulose or cellulose acetate.

Polysaccharides and heteropolysaccharides suitable as thickening agents have an average molecular weight of >1,500 g/mol, such as >5,000 g/mol, and i.e. >50,000 g/mol. In general, their average molecular weight is <250,000 g/mol.

A non-limiting polymer is the microbial anionic heteropolysaccharide xanthan gum, which is produced by Xanthomonas campestris and some other species under aerobic conditions having a molecular weight of 2 to 15×10⁶, and is available, for example, from Kelco under the trade name Keltrol®, for example, Keltrol® T (transparent) as a cream-colored powder or Keltrol® RD (readily dispersible) as white granules.

In an embodiment, the liquid, aqueous compositions are single-phase. However, this phase may contain water-soluble organic solvents such as alcohols.

In a non-limiting embodiment, an insoluble solid component may also be present as a separate, solid phase in single-phase compositions. Shaking such compositions temporarily forms an emulsion of the liquid phases, which disperses the solid phase therein.

Polyphase formulations are not preferred but are not excluded.

The term “liquid” denotes a composition which is flowable at room temperature (around 20° C.) and ambient pressure (about 1 bar at sea level). The term “liquid, aqueous composition” may also include gelatinous and pasty compositions.

The viscosity of the liquid phase(s) at 20° C. is 5 to 100,000 mPa·s, such as 10 to 5,000 mPa·s, for example 10 to 200 mPa·s, as measured by a Brookfield rotational viscometer of the type LVT or LVDV-II+ with a small sample adapter at a speed of 30 min⁻¹, wherein the spindle used as the measuring body should be selected according to Brookfield so that the torque lies within a favorable range and the measuring range is not exceeded. In this context, spindle 31 may be used and, if required at viscosities above about 240 mPa·s, spindle 25 is used.

The pH of the compositions is 2 to 10, such as 4 to 8, for example 5 to 7, both in the concentrated form and in the diluted application solutions. A pH value of about 6 to 6.5 is particularly suitable.

Corresponding pH values may range from 5 to 7 correspond approximately to the natural pH value of human skin, so that the compositions are tolerated by the skin and, in particular, avoid skin irritations due to basic pH values.

In a non-limiting embodiment, the liquid, aqueous compositions are neutral to slightly acidic, having a pH value from 2 to 7, such as from 3 to 7, for example from 3.5 to 7, i.e. from 4 to 6.5, such as from 5 to 6, in particular 5 to 6, for example 5.5, 6 or 6.5. To achieve such a pH value, acids can be added to the compositions. Inorganic acids, such as the mineral acids, for example hydrochloric acid, and organic acids, for example saturated or unsaturated C₁-C₆ mono-, di- and tricarboxylic acids and hydroxycarboxylic acids with one or more hydroxy groups such as citric acid, maleic acid, formic acid and acetic acid, aminosulfuric acid, C₆-C₂₂ fatty acids and anionic sulfonic acids, and mixtures thereof, for example the commercially available succinic acid-glutaric acid-adipic acid mixture with the tradename Sokalari®DCS made by BASF are suitable. Particularly non-limiting acids are citric acid, such as used in the form of their monohydrate citric acid×1 H₂O and the anionic sulfonic acids, as well as combinations of citric acid with one or more anionic sulfonic acids, especially with alkylarinsulfonic acids. The citric acid advantageously combines acid phase separation auxiliary agent properties and builder properties while the anionic sulfonic acids simultaneously act as acid and anionic surfactant.

Optionally, one or more alkalis may additionally be used, for example alkali metal, alkaline earth metal and ammonium hydroxides and carbonates and ammonia or amines, such as sodium and potassium hydroxides and alkanolamines, with monoethanolamine being used.

Since, for example, during the washing or cleaning process, pH-changing substances are frequently introduced into the washing or cleaning solution in a larger amount, corresponding buffer substances may be added, for example acetates, hydrogen phosphates, hydrogen sulfates, soda or alkali metal bicarbonates for stabilizing or buffering the pH value of the compositions in the dilution of application. Particularly suitable buffer systems are potassium hydrogen phthalate/sodium hydroxide, potassium dihydrogen phosphate/sodium hydroxide and the like.

Furthermore, a detergent or cleaner may comprise or consist of the liquid, aqueous composition.

The detergent or cleaner is a detergent.

Furthermore, the use of the liquid, aqueous composition as a detergent or cleaner for the improved stain removal is claimed, especially compared with agents with identical components but without carbohydrates or derivatives thereof, such as to increase the whiteness of a textile compared with agents without carbohydrates or derivatives thereof, in particular in a washing process.

The liquid aqueous composition may be used as a detergent, in particular for improved stain removal, compared to agents with identical components, but without carbohydrates or derivatives thereof.

The liquid, aqueous composition is used as a detergent for increasing the whiteness of a textile, compared with compositions having identical components, but without carbohydrates or derivatives thereof.

At least one carbohydrate or a derivative thereof may be used as a stain remover, wherein the carbohydrate has an acid value of <10 mg KOH/g and in which the carbohydrate structure has a molecular mass of 140 to 540 g/mol.

All aspects described herein in the context of the liquid, aqueous compositions as such also apply to the detergents and cleaners described and to the uses.

### EXAMPLES

### Example 1: Attempt to Improve Cleaning Power by on Top Dosing of 0.7 wt. % Disaccharide in the Absence of 1-hydroxyethane-(1,1-diphosphonic Acid) (HEDP)

A washing experiment was carried out at 40° C. and with 18° dH as a six-fold determination.

For the washing experiments, a liquid detergent (FWM) was used, which was dosed with 50 ml. The performance of the FWM without disaccharide was compared with the performance of the FWM to which 0.7 wt. % of the disaccharide was added.

The term “on top dosing” refers to an FWM to which the disaccharide has been added prior to the washing process.

The evaluation was carried out by color distance measurement according to the L*a*b* values and the Y values calculated from that served as a measure of the brightness. The difference of Y (after washing)−Y (before washing) for the stains below resulted in dY values. The ΔY values in the table below are defined as the difference between the dY values of the results of FWM with and without disaccharide for a particular type of stain.

TABLE 1

| | ΔY ((dY FWM with 0.7 wt. % disaccharide) − |
|---|---|
| Type of stain | (dY FWM without disaccharide)* |
| Tea | 0.6 |
| Beetroot | 0.6 |
| Coffee | 1.2 |
| Black currant juice | 0.7 |
| Curry | 0.4 |
| Red wine | 1.6 |

*No diphosphonic acid was added to the FWM with disaccharide or the FWM without disaccharide.

The dY values with the addition of the substance are greater than with the pure FWM, which corresponds to a higher degree of whiteness and thus improved stain removal. This result is reflected in the positive ΔY values in the table.

### Example 2: Attempt to Improve the Cleaning Power by on Top Dosing of 1% Disaccharide in the Presence of 1-hydroxyethane-(1,1-diphosphonic Acid) (HEDP)

A washing experiment was carried out at 40° C. and with 18° dH as a six-fold determination.

For the washing experiments, a liquid detergent (FWM) was used, which was dosed with 50 mL. The performance of the FWM with diphosphonic acid but without disaccharide was compared with the performance of FWM with diphosphonic acid to which 1.0 wt. % of the disaccharide was added.

The term “on top dosing” as used herein refers to an FWM to which the disaccharide and the diphosphonic acid have been added prior to the washing process.

The evaluation was carried out by color distance measurement according to the L*a*b* values and the Y values calculated from that served as a measure of the brightness. The difference of Y (after washing)−Y (before washing) for the stains below resulted in dY values. The ΔY values in the table below are defined as the difference between the dY values of the results of FWM with and without disaccharide for a particular type of stain.

TABLE 2

| | ΔY ((dY FWM with diphosphonic acid with |
|---|---|
| | 1.0 wt. % disaccharide) − (dY FWM with |
| Type of stain | diphosphonic acid without disaccharide) |
| Blueberry juice | 1.4 |
| Blood | 2.9 |
| Tea | 1.5 |
| Drippings | 1 |

The dY values with the addition of the substance are greater than with the pure FWM, which corresponds to a higher degree of whiteness and thus improved stain removal. This result is reflected in the positive ΔY values in the table.

### Example 3: Attempt to Improve the Cleaning Power by on Top Dosing of 2% Disaccharide in the Presence of 1-hydroxyethane-(1,1-diphosphonic Acid) (HEDP)

A washing experiment was carried out at 40° C. and with 18° dH as a six-fold determination.

For the washing experiments, a liquid detergent (FWM) was used, which was dosed with 50 mL. The performance of the FWM with diphosphonic acid but without disaccharide was compared with the performance of FWM with diphosphonic acid to which 2.0 wt. % of the disaccharide was added.

The term “on top dosing” as used herein refers to an FWM to which the disaccharide and the diphosphonic acid have been added prior to the washing process.

The evaluation was carried out by color distance measurement according to the L*a*b* values and the Y values calculated from that served as a measure of the brightness. The difference of Y (after washing)−Y (before washing) for the stains below resulted in dY values. The ΔY values in the table below are defined as the difference between the dY values of the results of FWM with and without disaccharide for a particular type of stain.

TABLE 3

| | ΔY ((dY FWM with diphosphonic acid with |
|---|---|
| | 2.0 wt. % disaccharide) − (dY FWM with |
| Type of stain | diphosphonic acid without disaccharide) |
| Blueberry juice | 1.6 |
| Drippings | 1.4 |

The dY values with the addition of the substance are greater than with the pure FWM, which corresponds to a higher degree of whiteness and thus improved stain removal. This result is reflected in the positive ΔY values in the table.

What is claimed is:

1. A liquid aqueous composition comprising:
at least one carbohydrate or derivative thereof having an acid value of <10 mg KOH/g; wherein the at least one carbohydrate or derivative thereof has a molecular mass ranging from 140 to 540 g/mol;
at least one surfactant;
optionally at least one complexing agent;
optionally at least one polymer;
optionally at least one enzyme; and
optionally at least one excipient.

2. The liquid aqueous composition according to claim 1, wherein the at least one carbohydrate or derivative thereof comprises a mono-, di- or trisaccharide or a derivative thereof.

3. The liquid aqueous composition according to claim 1, wherein the at least one carbohydrate or derivative thereof has an acid value of <5 mg KOH/g.

4. The liquid aqueous composition according to claim 1, wherein the basic carbohydrate structure has a molecular mass of 150 to 520 g/mol.

5. The liquid aqueous composition according to claim 1, wherein the at least one carbohydrate or derivative thereof is present in an amount ranging from 0.01 to 40 wt. % based on the total weight of the liquid aqueous composition.

6. The liquid aqueous composition according to claim 1, wherein the at least one surfactant comprises an anionic surfactant in an amount ranging from 0.01 to 45 wt. % based on the total weight of the liquid aqueous composition.

7. The liquid aqueous composition according to claim 1, wherein the at least one surfactant comprises a nonionic surfactant in an amount ranging from 0.01 to 45 wt. % based on the total weight of the liquid aqueous composition.

8. The liquid aqueous composition according to claim 1, wherein the at least one complexing agent comprises a phosphonic acid, a derivative thereof, or a salt thereof.

9. The liquid aqueous composition according to claim 1, wherein the at least one complexing agent is present in an amount ranging from 0.01 to 50 wt. % based on the total weight of the liquid aqueous composition.

10. The liquid aqueous composition according to claim 1, wherein the at least one polymer is present in an amount ranging from 0.01 to 30 wt. % based on the total weight of the liquid, aqueous composition.

11. The liquid aqueous composition according to claim 1, wherein the at least one enzyme is selected from the group consisting of amylases, proteases, peroxidases and lipases; and wherein the at least one enzyme is present in an amount ranging from 0.00001 to 5 wt. % based on the total weight of the liquid aqueous composition.

12. The liquid aqueous composition according to claim 1, wherein the composition is substantially free of complexing agents based on a phosphonic acid, a derivative thereof, or a suitable salt thereof.

13. A detergent or cleaner comprising the liquid aqueous composition according to claim 1.
